(19) United States
(12) Patent Application Publication
(10) Pub. No.: US 2024/0292078 A1
(43) Pub. Date: Aug. 29, 2024

(54) SYSTEM AND METHOD FOR STRATEGIC CROSS-POLARIZATION VIA MOTORIZED MEANS

(71) Applicant: U.S. Army DEVCOM, Army Research Laboratory, Adelphi, MD (US)

(72) Inventors: Mahdi Al-Husseini, Enterprise, AL (US); Joshua L. Barnett, Standord, CA (US); Anthony Chen, Stanford, CA (US)

(21) Appl. No.: 18/584,890

(22) Filed: Feb. 22, 2024

Related U.S. Application Data
(60) Provisional application No. 63/448,324, filed on Feb. 26, 2023.

(51) Int. Cl. H04N 23/55; G02B 27/28; G06T 7/13; H04N 23/51; H04N 23/53

(52) U.S. Cl. CPC H04N 23/55; G02B 27/281; G06T 7/13; H04N 23/51; H04N 23/53

(57) ABSTRACT

A motorized cross-polarizer instrument for providing strategic cross-polarization is provided. In one exemplary embodiment, the instrument includes outer and inner housings. A polarizer, mounted inside the inner housing, permits rotation of the polarizer in tandem with the inner housing. A capstan, mounted inside the outer housing, permits rotation of the inner hosing relative to the outer housing. And a motor, connected to the capstan, rotates the inner housing. The instrument may be located on or place over a polarized digital display unit that includes a polarizer film thus forming a display system for providing strategic cross-polarization.

### CROSS REFERENCE TO RELATED APPLICATION(S)

This application claims the benefit of U.S. Provisional Patent Application No. 63/448,324 filed Feb. 26, 2023, which is herein incorporated by reference in its entirety for all purposes.

### GOVERNMENT INTEREST

The invention described herein may be manufactured, used, and licensed by or for the United States Government.

### BACKGROUND

### 1. Technical Field

The present invention pertains to cross-polarization, and more particularly to the motorized and strategic rotation of a polarized filter to achieve differential levels of relative image brightness intensity as a function of the location within the field of view of the attached image capture system, to both improve the spatial identification of liquid crystal display boundaries within the field of view of a corresponding image capture system for certain computer vision applications and reduce unwanted specular or diffuse reflection from polarized sources in professional photography.

### 2. Background Art

Polarizers are used in general to block some portion of light forming a visible scene based on the properties of the light with respect to the orientation and location in space of the viewer. There exist prior art related to the use of polarizers for security purposes, where a screen containing information emits polarized light such that the information can only be intelligibly viewed using an auxiliary device that also consists of a polarizer (See, e.g., U.S. Pat. No. 9,898,721). Similar prior art for security purposes exists to scale across an entire working environment where the work environment is still visible but information on screens has an altered appearance due to the use of polarizers (See, e.g., U.S. Pat. No. 10,061,138). More in line with single device interaction, prior art exists that also incorporates polarization (among other techniques) for obfuscating sensitive user information on a screen (See, e.g., U.S. Pat. No. 8,867,780).

### 3. Background

A variety of applications involving computer vision tasks in the presence of a cluttered environment can render object detection both an expensive and unreliable task—especially when this affects a deeper pipeline of inference tasks where small errors can be magnified by initial errors in regions of interest detection. For example, a computer vision pipeline to read text of an image usually consists of at least two parts: an algorithm that detects the presence of interpretable text in the image as well as an algorithm to translate the text in the region of interest—usually much more computationally intensive and thus requires a smaller region of interest compared to the full image. For this reason, a method for more reliably and robustly detecting regions of interest prior to passing to the text translation algorithm can lead to overall better performance in terms of computational resources as well as the overall accuracy of the computer vision pipeline in terms of its ability to detect and correctly translate text.

For some applications, the region of interest may be a polarized liquid crystal display (LCD) screen, which may be information dense especially in the case of screens dedicated to displaying diagnostic and performance data. An example of such a screen may be the primary flight display of the glass cockpit of an aircraft. In such an example, the environment is uniquely difficult for conventional detection techniques to accurately and robustly identify these displays in order to extract relevant flight information due to the large number of extraneous dials, buttons, switches, and auxiliary displays. In this scenario, alternative methods for detecting these displays are necessary in order to properly identify these screens as the region of interest in the field of view of an image capture system operating in the cockpit for the purpose of harvesting flight data directly from the primary flight display.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 illustrates an example of an application of polarized display identification, to include subcomponents for a computing device and image capture system used in concert with a motorized cross-polarizer, in accordance with an embodiment of the present invention.

FIG. 2 depicts a flowchart illustrating an example of image collection to boundary identification steps, in accordance with an embodiment of the present invention.

FIG. 3 depicts the variable orientation of the motorized polarizer used to determine regions within the field of view that contained a polarized light source, where the particular choice in orientation has resulted in an asymmetric reduction brightness as a function of the location within the field of view.

FIG. 4 depicts the utilization of information between the two different images of the same scene using different polarizer orientations to determine where polarized light source is located and subsequently the border of the region of interest used in further computation.

FIGS. 5A-5E depict the motorized cross-polarizer at various orthographic projections (i.e., views), in accordance with an embodiment of the present invention.

FIG. 6 depicts an exploded view of the motorized cross-polarizer in accordance with an embodiment of the present invention.

### DETAILED DESCRIPTION

The robust and accurate automated recognition of the borders of polarized light displays are an important component of computer vision pipelines that endeavor to transcribe visual or textual information present on displays within a scene observed by an image capture system. The present invention would allow for the placement of the image capture system used to observe the given scene to be done without particularly specific guidance other than to place the displays in question within the field of view of the image capture system. The alternative would be a laborious calibration step necessary every time the location of the image capture system is adjusted, or the display would have to be outlined with visual markers which may not be allowed from a regulatory or practical perspective. Feature-matching algorithms also exist for locating specific template images in the field of view of an image capture system. For example, the well-known Open Source Computer Vision software library, OpenCV, includes brute force methods using scale invariant feature transformer (SIFT) as well as the fast library for approximate nearest neighbors (FLANN). They generally operate by matching computed features in both a reference and query image, where one wishes to find where in the query image the reference image may occur. However, they require both computationally expensive operations as well as the identification of a template image. Instead, this automated system would be robust to large changes in the view of the image capture system due to jostling, vibrations, or any other source of image capture system movement relative to the information-containing displays of relevance. The embodiments of the present invention as described in the detailed description are not meant as an exhausted description as other embodiments may be possible. They pertain to cross-polarization, and more particularly to the motorized and strategic rotation of a polarized filter to achieve differential levels of relative image brightness intensity as a function of the location within the field of view of the attached image capture system, to both improve the spatial identification of liquid crystal display boundaries within the field of view of a corresponding image capture system for certain computer vision applications and reduce unwanted specular or diffuse reflection from polarized sources in professional photography. Integration of embodiments of invention in aircraft cockpits with digital displays enables improved use of computer vision applications designed to enhance aviation operations. The robust and accurate automated recognition of the borders of polarized light displays are an important component of computer vision pipelines that endeavor to transcribe visual or textual information present on displays within a scene observed by an image capture system. The various embodiments allow for the placement of the image capture system used to observe the given scene to be done without particularly specific guidance other than to place the displays in question within the field of view of the image capture system.

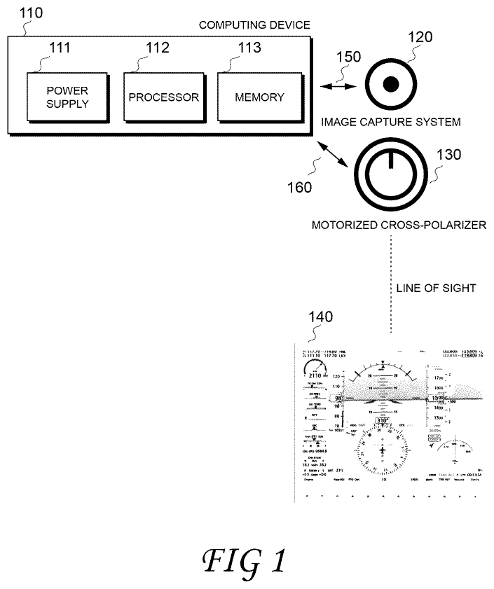

The figures will now be discussed in-depth to describe aspects of the present invention. FIG. 1 illustrates an example of one embodiment of the invention, to include subcomponents for a computing device 110. Computing device 110 may include, but is not limited to, a power supply 111, processor 112, and memory 113. Power supply 111 may be an internal battery whose electrical specifications are designed to support various computing device 110 subcomponents. Power supply 111 may also include a power converter designed to translate alternating current power from a connected electrical outlet to the requisite direct current power required for operations. Processor 112, which may consist of any combination of logical circuitry capable of processing digital information to include ASICs, GPUs, DPUs, and more, may access memory 113, which may consist of any combination of volatile and non-volatile memory to include ROM, EPROM EEPROM, flash memory, DRAM, and more. Processor 112 may execute instructions stored in memory 113. Memory 113 may further contain trained machine learning models developed to support proposed invention tasks. Machine learning models of relevance include screen object detection, number object detection, horizon line detection, optical character recognition, and more. Computing device 110 receives information from image capture system 120 via wired or wireless connection 150, and transmits instructions to motorized cross-polarizer 130 via wired or wireless connection 160.

Image capture system 120 may include one or more cameras each within line of sight of one or more polarized displays 140 to acquire the boundaries of one or more polarized displays 140. Both still and video cameras are viable options for capturing image data here depending on how frequently one may need to refresh the screen location; although, we note ordinary cameras for capturing still frames may provide higher resolutions than most video cameras. The minimum required resolution would depend on the field of view of the camera and the distance from the filter (or lens) to the display in question. We expect standard definition video (i.e., 480×480 pixels) to suffice with most camera lenses in most embodiments. Multiple cameras positioned in different locations may allow for improved overall image capture. Image capture system 120 may apply night vision light intensification, which amplifies existing visible light in low illumination environments. Lens types for image capture system 120 may include fisheye or wide angle which enables a wider field of view while a standard lens will have a smaller field of view with less image distortion. Image capture system 120 feeds captured data in real-time to computing device 110 via wired or wireless connection 150.

Many liquid crystal displays (LCDs) include a polarizer, otherwise one would not be able to see the contents of the screen clearly. One non-limiting exemplary model for display 140 is the Garmin Model G1000 display unit; specifically, it is an LCD display that includes a polarizer film layer behind the light display, providing a polarized light source. The polarizer of the screen is installed internally by the manufacturer. The underlying basis of the present invention operate on the assumption that the screen we wish to identify is already producing polarized light. This would work for any type of display screen which includes a polarizer. This means for that particular kind of display or screen, it produces light that has already passed through a polarizer; if the motorized polarizer chooses an orientation that is orthogonal to the orientation of the polarizer (assuming a linear polarizer), then this is point where we should have a minimum amount of light passing through to the camera sensor in that region. (In the case the display unit is not polarized then a separate polarizer could be placed over the display unit such that it would now produce polarized light. Such a polarizer should at least cover the display such that the full extent of the display could be recognized by the motorized cross polarizer.). We do not know in principle which orientation will give us this minimum and maximum intensity until we test because we do not know the orientation of the polarizer in the display with respect to the motorized polarizer until we observe the effect of changing the orientation.

Motorized cross-polarizer 130 is an instrument for providing strategic cross-polarization that may be attached to image capture system 120 to facilitate polarized display 140 identification. Motorized cross-polarizer 130 is composed of, at a minimum, a linearly polarized image acquisition filter and a motor. The polarizer may be an ordinary linear polarizer (e.g., configured to transmit p- or block s-polarization), or it could be an integrated with a lens, such as being a lens that is polarized, or a regular lens with a polarized filter place on top. We do not expect any functional difference between the two, so long as they can be rotated. One non-limiting exemplary linearly polarized image acquisition filter which may be used is Tiffen Company Model 46POL linear polarized filter. It could also be a simple linear polarizer film similar to what is used in many LCD displays. Additionally, other types of polarizers might be used in other embodiments. For instance, the polarizer might also by a circular polarizer that consists of a linear polarizer and then a quarter wave-plate. We note that great care must be taken to ensure that the linear polarizer is what is facing the source of light (the screen) for this to work. In other words, the quarter wave plate should be facing the camera lens and the linear polarizer should face the screen.

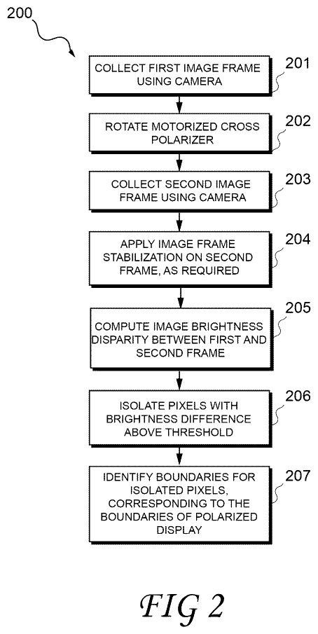

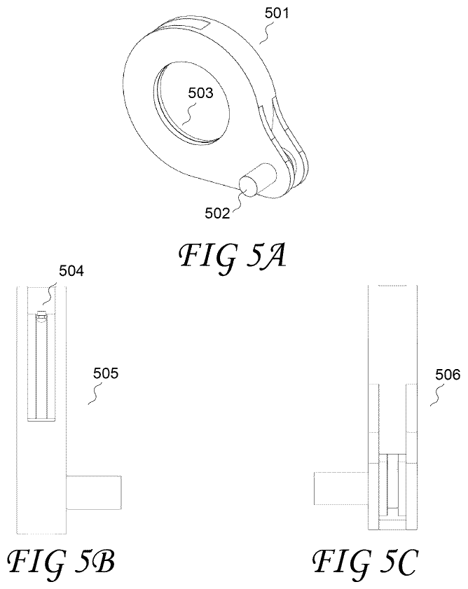

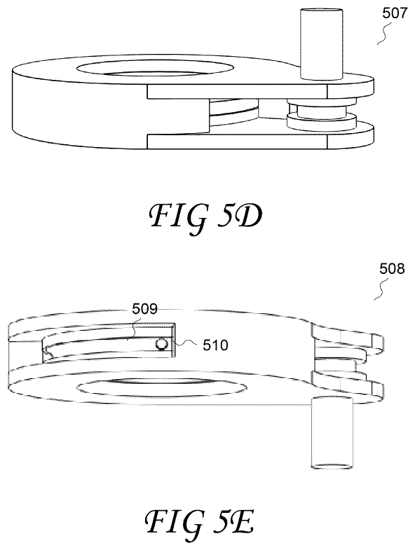

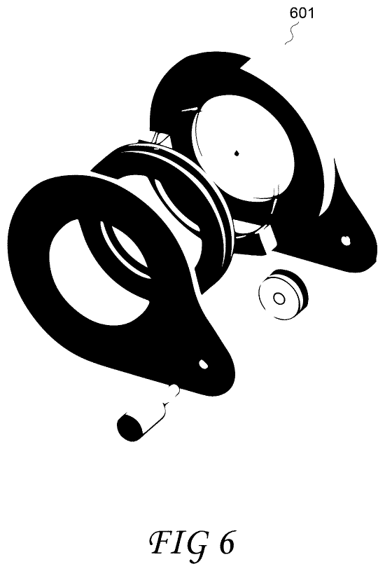

The motor may be an electric motor such as an AC or DC motor in some embodiments. The linearly polarized image acquisition filter and the motor are mechanically linked. One embodiment of a mechanical linkage between the linearly polarized image acquisition filter and the motor is discussed in FIGS. 5 and 6. The motor, and thus the motorized cross-polarizer 130, receives instructions from computing device 110 via wired or wireless connection 160 to rotate the linearly polarized image acquisition filter as part of the process discussed in FIG. 2.

The size of the polarizer used in the instrument needs only to cover the aperture making up the camera such that all of the light passing through has also had to pass through the polarizer placed in front of the camera.

The motor rotates the polarizer placed over the polarized digital display unit while the fixed camera views images emitted by the polarized digital display unit. When the polarizer is rotated such that it and the digital screen being viewed are “cross-polarized”, the light from the screen is minimized. In some instance, it disappears/is cut. We note there is a similar phenomenon is experienced when viewing a polarized screen using ordinary polarized sunglasses—there is a viewing orientation where the polarized screen disappears altogether. Our methodology controls that phenomenon selectively to identify the boundaries of any digital display, using computer vision techniques. Once the screen boundaries are identified, homography and other geometric techniques may be used to project external information on the existing screen boundaries (for instance, a digital advertisement in a real-world digital frame) or used to crop a viewed environment to just the boundaries of a digital screen (for instance boundary detection for computer vision and artificial intelligence tasks).

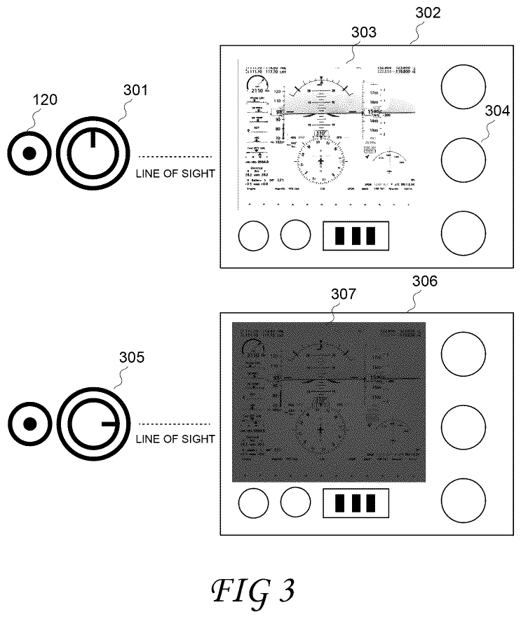

FIG. 2 is a flowchart describing the process by which the boundaries of a polarized display 140 are identified in the line of sight of the combination of 120 and 130, generally designated as 200. Step 201 indicates that the first image frame using 120 is captured and stored through 110 using orientation of 130 as illustrated by 301 providing the image frame 302 seen in FIG. 3. The initial orientation of the polarizer here is somewhat arbitrary as one cannot know what orientation is with respect to the polarizer inside of the LCD display. This step may encompass a variety of image preprocessing steps prior to storage to ensure a legible or otherwise useful image, including filters—which may include individually or some combination of gaussian, median, grayscale, etc.—to enhance the image for steps further down the flow chart. A plurality of representations of 302 may be stored in this vein, including, for example: the raw image captured by 120 and a gaussian-filtered, grayscale representation obtained through computation using 110. The camera may be capturing data continuously (perhaps, 30-60 Hz depending on the specification), so the data would technically be a video clip; however, only a single frame would be used at a time. How useful the next frame would be is determined by how quickly the polarizer is rotating. If it rotates by a small amount between frames, there will likely be a very small difference in the intensity map obtained from the frame.

After 302 has been collected, processed, and stored as described in 201, step 202 indicates the motorized cross-polarizer is rotated, which is illustrated in 305 by the movement of the orientation marker compared to 301. The mechanical process is described in more detail with respect to FIGS. 5 and 6. Algorithmically, the most relevant outcome of this process is that the orientation of 130 changes with respect to 120, which provides for a plurality of directions and magnitudes of rotation. For example, 130 may rotate by the smallest increment allowed by the motor actuating 130 (for instance, as little as 1 degree) or it could rotate by as much as a half-period (e.g., up to 90 degrees) of the polarizer to achieve maximum difference in orientation of the polarizer (e.g., to measure s-polarization instead of p-polarization). The amount of rotation to achieve orientation 130, however, cannot be known a priori as one does not know the orientation of the polarizer until actually rotating it. Further, the direction the motorized polarizer moves could be constant, or it could alternate directions between frame captures. The choice of magnitude and direction will influence the magnitude of difference between 302 and 306. For instance, it could vary roughly continuously from 0 to 90 degrees in terms of the cross polarization, not discretely such that only 90 and 0 degrees are used. So, between taking frames, the polarizer could rotate stepwise, for instance, in say 10-20 degree step intervals.

Next, 203 describes the capture of 306 which follows the same process as described in 201 with, however, an altered orientation of the motorized cross-polarizer as indicated in 305 compared to 301. The key to this step is that the region of interest 303 and 307 will have different image brightness intensities compared to the rest of the full frames 302 and 306, which will help to isolate this region from unwanted features such as 304. This difference could correspond to a brighter region 303 compared to region 307 (as is depicted in FIG. 3) or it could correspond to a brighter region in 307 compared to region 303 (not shown).

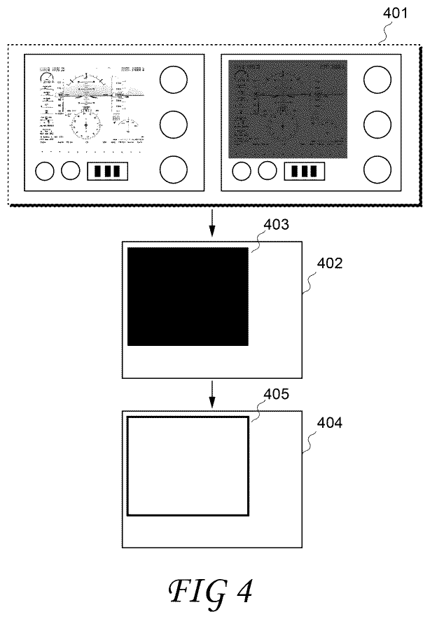

The next step 204 involves the frame stabilization of 302—the target—compared to 306—the input—giving the comparison 401 seen in FIG. 4. Note another realization of this involves switching 302 and 306 such that they are target and input, respectively. This is accomplished through various standard computer vision algorithms that, for example, may seek to match features of each frame in order to apply either affine or nonlinear transformation; a non-limiting example of such an algorithm is ORB which stands for “Oriented FAST and Robust BRIEF.” It was created in 2011 and combines the two algorithms of FAST and BRIEF. FAST, short for “Features from Accelerated and Segmented Test,” is an efficient technique for finding corner points. BRIEF, short for “Binary Robust Independent Elementary Features,” is a technique to determine keypoints of an object and coverts them into a binary feature vector to represent the said object. The following paper: E. Rublee et al., “ORB: an efficient alternative to SIFT or SURF,” 2011 IEEE International Conference on Computer Visions, 2564-2571, herein incorporated by reference in its entirety, highlights ORBs improvements over the Scale-Invariant Feature Transform (SIFT) and the Speeded-Up Robust Feature (SURF), two other feature-detecting and matching algorithms. Feature matching looks to identify like components in different frames, to support object recognition, image stitching, visual mapping, and other processes that may occur over time. Per the introduction, SIFT was one of the first original feature mapping algorithms. It performed well for many applications, but proved computationally expensive. SURF has a lower computational cost and excels in orientation, but otherwise falls short in performance relative to SIFT. ORB outperforms SIFT and SURF in most situations, and has the fastest computation time of the three. While we note the aforementioned tradeoffs, we believe all aforementioned feature detection and matching algorithms may be used in embodiments.

Ancillary features such as 304 may be useful in this respect as a transformed version is contained in 306. Because this is a computationally intense process, a filtered version of the images is often used, such as a grayscale and/or down-sampled version of the image. This is a necessary step that enables pixel-by-pixel comparison of 302 to 306 to determine the regions of the line of sight that contain differences in image brightness intensity. The necessity of this step is determined by the comparison of time scales of steps 201-203 to the period of oscillations experienced by 120 due to relative motion compared to the scene in line of sight 302 or 306. Assuming the magnitude of the oscillations experienced by 120 are small relative to the size of the region of interest, if the largest time scale in steps 201-203 is much smaller than the oscillation time scale, this step may be unnecessary.

Step 205 describes the computation of the difference in image brightness between stabilized images shown in 401 as a function of the line of sight of 120 equipped with 130 at orientation indicated by 301 or 305. A pixel-by-pixel comparison is computed, which could include for example the absolute difference in the grayscale intensity of each of the images in 401. The resulting image would then undergo yet another filter in step 206, such as a median or contour filter, to determine contiguous regions where the brightness intensity of the image is greater than some pre-defined absolute or relative threshold. This may also involve another filter ignoring regions not within some predefined area ratio with respect to the area of line of sight. This gives an overall processed binary image 402 with contiguous region 403 filled in with either zeros or ones in a Boolean data structure opposite of the portion of the image not captured by the previous filter.

Finally, in step 207 the boundaries 405 of the region 403 in 402 are identified giving 404. This can be accomplished through various means, including using standard corner detection algorithms (such as those previously mentioned) which allow for the corners of the filled region 403 to be detected; linear functions defining the boundary between the four points provided by the corner detection algorithm can provide 405. For robustness, this process involves another step that filters points that do not form a valid affine transformation of a rectangle. Another realization would involve the use of line detection algorithms which would provide for the identification of 405 directly. There are two commonly applied categories of line detection algorithms—those using hough transforms and those using convolution-based techniques. The hough transform is a multi-step feature extraction process involving 1.) an edge image, 2.) the Hough space, 3.) mapping edge points to the Hough space, and 4.) line representation and drawing. All four steps are explained in detail the following paper: Tomasz Kacmajor, “Hough Lines Transform Explained,” Medium.com, Jun. 5, 2017, https://medium.com/@tomasz.kacmajor/hough-lines-transform-explained-645feda072ab, herein incorporated by reference in its entirety. A convolutional method essentially uses a convolutional kernel to detect lines of a particular width. This process is explained in more detail here “Line Detection,” at https://homepages.inf.ed.ac.uk/rbf/HIPR2/linedet.htm, herein incorporated by reference in its entirety. Both these known techniques may be employed in various embodiments for line detection.

FIGS. 5A-5E and 6 depict a motorized cross-polarizer 130 that is placed in front of the image capture system 120 to filter the image and identify the location of polarized display 140.

More particular, FIG. 5A shows an isometric view. 505 and 506 show the side views (FIG. 5B and FIG. 5C) of the device and 507 and 508 show two additional views of the device (FIG. 5D and FIG. 5E). FIG. 6 shows an exploded view 601. Element 501 is an outer housing that serves as the casing for all the internal parts, which include an electric motor assembly 502 and an inner housing, which includes a polarized lens 503 (or other polarizer) that is attached to a rotating frame 504. Both the outer and inner housings might be formed of plastics but can also be manufactured out of other materials, such as machined aluminum or other metals for durability reasons. The inner housing 504 is able to rotate within the outer housing 501, thus achieving the desired polarization filtering for the image capture system. In some embodiments, to reduce friction therebetween, there may be a bearing or race positioned between the inner and outer housings. The electric motor assembly 502 is formed of an electric motor and a pulley attached to the output shaft of the motor, which is placed within the outer housing 501. This pulley is rotationally coupled with the rotating polarized lens frame 504 by the use of a tendon in a capstan drive configuration. (A capstan is a rotating mechanical device which multiplies the pulling (rotational) force. It is typically used on board ships or in shipyards for moving ropes, cables or chains). We configure a capstan for an entirely different purpose in the motorized cross-polarizer 130. In our capstan configuration, we include the polarizer 503. A first tendon attaches to rotate the polarizer in a first direction, and a second tendon attaches to rotate the polarizer in a second direction opposite the first direction. The tendon is tied to the hook-end attachment points on the inner housing. Element 510 indicates the hook end attachment point for the inner housing; it is a slot where the tendon would be. The electric motor turns the output shaft pulley thus turning the polarized lens frame by the desired amount. The capstan rotates in a first direction (e.g., clockwise) and the second opposing direction (e.g. counterclockwise). A first torque can be applied to the capstan about which the first tendon is winded. This, in turn, permits simultaneously loosening the second tendon which is winded about the capstan in a direction opposite the first tendon; and simultaneously rotating the polarizer to which the first and second tendons are both attached, in the first direction. A second torque applied to the capstan about which the second tendon is winded. This, in turn, permits simultaneously loosening the first tendon which is winded about the capstan in a direction opposite the second tendon; simultaneously rotating the polarizer to which the first and second tendons are both attached, in the second direction.

There should be sufficient system dampening to isolate vibrations that may impede image clarity during operation. This may be achieved through a combination of mechanical rubber dampening for dampening the higher frequency vibrations from the environment and an elastic cords suspension for dampening the lower frequency vibrations. Suggested are multiple (e.g. four or more) elastic cords connecting the mounting plate of the assembly and the motorized cross-polarizer. As this is the only connection between the two parts of the assembly, these elastic cords in tension provide vibration isolation, on top of traditional rubber dampeners used to connect the mounting plate and the mounting surface.

The functionality of motorized cross-polarizer 130 is achieved by rotating the polarizer 503, and the method presented above is one way to achieve this functionality. Another embodiment of motorized cross-polarizer 130 involves placing the polarizer inside of a machined gear assembly and having the electric motor turn this gear assembly. This can be achieved by mounting the polarizer on the inside of a gear (e.g. spur gear) and utilize another gear (e.g. spurgear) driven by the electric motor to turn this polarizer gear assembly. A third embodiment of motorized cross-polarizer 130 involves the polarizer/lens secured inside of a rotating assembly, similar to the embodiment presented in the drawing, but instead of using an ordinary electric motor to turn the rotating assembly, an electromagnet can be used as the motor to rotate the polarized lens. The polarized lens only needs to turn 90 degrees to achieve the desired effect, and a permanent magnet can be mounted on the inner housing, along the rotating arc, which is still able to rotate within the outer housing. Two or more electromagnets can be mounted at the two ends of the 90-degree rotating arc on the outside housing. By energizing the electromagnet to different polarities, it can push or attract the permanent magnet to rotate the desired 90-degrees. The advantages of using this method to rotate the polarized lens is that it is quiet and fast, compared to using an ordinary electric motor. And there are no risks involved overheating the motor or accidentally stalling the electric motor in a situation where the encoder on the motor is broken. However, one disadvantage is that the electromagnets must stay powered during the entire duration of device operation to hold the polarized lens in place.

We note that the prior art inventions mentioned in the Background Art section above effectively do the opposite of what we have disclosed herein—that is, the screen being viewed is obfuscated without the use of a polarizer, and the purpose of the polarized lens is to un-obfuscate it for viewing of sensitive information. By contrast, our embodiments essentially function in reverse—by rotating the polarizer, we can find the appropriate cross-polarization orientation of the polarizer such that minimum light is emitted by the screen to the camera. Then, knowing where the “darkness” is, we can identify the screen boundaries. This is essentially a clever form of boundary detection that employs a polarizer and other hardware to enable a general case of screen detection in near any environment. The ability to automatically identify the boundaries of screens and frames is an area of active academic research and significant industry interest.

Several military platforms possess digital displays, to include the cockpits of the AH-64, UH-60M, and CH-47, as well as certain ground vehicles such as the M1A2. Embodiments of the present invention enable the rapid identification of those screens from within the vehicles by camera systems, in support of computer vision tasks that may enhance operational requirements. For example, U.S. Patent Application Publication No. 2022/0180647, herein incorporated by reference in its entirety, introduces a computer vision system designed to collect, process, and output flight information in support of military aviation tasks; embodiments of our invention would tangibly improve its operations.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A motorized cross-polarizer instrument for providing strategic cross-polarization, the instrument, comprising:
an outer housing;
an inner housing, mounted inside the outer housing, the inner housing being mounted to permit rotation of the inner housing relative to the outer housing;
a polarizer, mounted inside the inner housing, the polarizer being mounted to permit rotation of the polarizer in tandem with the inner housing;
a capstan, mounted inside the outer housing, the capstan being mounted to permit rotation of the inner housing relative to the outer housing; and
a motor, connected to the capstan, for rotating the inner housing.

2. The instrument of claim 1, wherein the inner housing includes a hook-end attachment.

3. The instrument of claim 2, further comprising:
a first tendon, winded on the capstan, routed clockwise around the inner housing, and affixed to the hook-end attachment; and
a second tendon, winded on the capstan, routed counterclockwise around the inner housing, and affixed to the hook-end attachment.

4. The instrument of claim 3, further comprising a pulley, attached to an output shaft of the motor, which is rotationally coupled to the polarizer by the first and second tendons.

5. The instrument of claim 1, wherein the polarizer comprises a linear polarizer or a circular polarizer.

6. The instrument of claim 1, wherein the polarizer comprises a polarized lens or comprises a polarizer placed over a lens.

7. The instrument of claim 1, wherein the motor is an electric motor.

8. The instrument of claim 7, further comprising: a gear assembly rotated by the motor, wherein, in the gear assembly, the polarizer is connected to a first gear which is driven by a second gear connected to the motor.

9. The instrument of claim 1, wherein the motor comprises an electromagnet magnetic assembly.

10. The instrument of claim 9, wherein the electromagnet assembly comprises an electromagnet and at least permanent magnet which rotates relative to the electromagnet.

11. The instrument of claim 9, wherein the electromagnet assembly comprises at least two electromagnets positioned at different rotational positions of the polarizer.

12. A display system for providing strategic cross-polarization, the display system comprising:
a polarized digital display unit;
an image capture system comprising at least one camera positioned within the line of sight of the polarized digital display to capture image data;
the motorized cross-polarizer instrument of claim 1 positioned in front of the aperture of the at least one camera; and
a computing device configured to control rotation of the polarizer of the instrument and analyze the captured image data at different rotational positions of the polarizer.

13. The display system of claim 12, wherein the computing device is further configured to:
apply image frame stabilization to the captured image data at different rotational positions of the polarizer.

14. The display system of claim 12, wherein the computing device is further configured to:
compute image brightness disparities in the captured image data at different rotational positions of the polarizer;
isolate pixels with a brightness difference above a threshold; and
identify boundaries for isolated pixels corresponding to the boundaries of the polarized display.

15. The display system of claim 14, wherein the computing device is further configured to:
apply homography and/or other geometric techniques to project external information on the polarized digital display unit once the screen boundaries have been identified; and/or
crop a viewed environment to the identified boundaries of the polarized digital display unit.

16. The display system of claim 12, further comprising a dampening system which includes a mechanically damped plate supporting the instrument and multiple elastic cords in tension which connect to the damped plate to a mounting surface.

17. A method for operating an instrument for providing strategic cross-polarization containing a polarizer, a first tendon attached to rotate the polarizer in a first direction, and a second tendon attached to rotate the polarizer in a second direction opposite the first direction, the method comprising:
applying a first torque to a capstan about which the first tendon is winded;
simultaneously loosening the second tendon which is winded about the capstan in a direction opposite the first tendon; and
simultaneously rotating the polarizer to which the first and second tendons are both attached, in the first direction.

18. The method of claim 17, further comprising:
applying a second torque to a capstan about which the second tendon is winded;
simultaneously loosening the first tendon which is winded about the capstan in a direction opposite the second tendon; and
simultaneously rotating the polarizer to which the first and second tendons are both attached, in the second direction.

19. The method of claim 18, wherein the first direction is clockwise and the second direction is counterclockwise.

20. A method for identifying the boundaries of a polarized digital display in one or more image frames, using a motorized cross-polarizer, the method executed by a computing device, the method comprising:
receiving, at the computing device, from an image capture system with an attached motorized cross-polarizer, a first image frame;
rotating a polarizer contained within the motorized cross-polarizer by a predetermined degree and in a predetermined direction;
receiving, at the computing device, from the image capture system with attached motorized cross-polarizer, a second image frame;
comparing, using the computing device, the first and second image frames to identify areas of significant image brightness disparity corresponding to the presence of the polarized digital display; and
calculating, using the computing device, the boundaries of the polarized digital display in the first and second image frames given identified areas of significant relative spatial image brightness intensity disparity.

21. The method of claim 20, wherein the rotating comprises rotating the polarizer from about 0 to 90 degrees continuously at a minimum interval or at step intervals.

22. The method of claim 20, wherein the calculating utilizes one or more of the FAST, BRIEF, ORB, SIFT and SURF techniques.
